(19) United States
(12) Patent Application Publication
(10) Pub. No.: US 2024/0051799 A1
(43) Pub. Date: Feb. 15, 2024

(54) GAP-JUMPING OVERHEAD CRANE

(71) Applicant: RAY GIVENS, London (CA)

(72) Inventor: RAY GIVENS, London (CA)

(21) Appl. No.: 18/232,598

(22) Filed: Aug. 10, 2023

Related U.S. Application Data
(60) Provisional application No. 63/396,671, filed on Aug. 10, 2022.

(51) Int. Cl. B66C 17/06; B66C 9/14

(52) U.S. Cl. CPC B66C 17/06; B66C 9/14

(57) ABSTRACT

A gap jumping overhead crane for use with two parallel runways each having a first and second end and a gap between their first and second ends. The crane has a hoist mounted on a bridge having opposing ends that extends between the two parallel runways. The bridge is slidably mountable to the two parallel runways at each of its ends by an end truck. Each end truck has two ends and at least three load wheels attached to the end truck. At least two of the load wheels are separated by a distance greater than the size of the gap to permit the crane to cross the gap in the runways.

### FIELD OF THE INVENTION

The present invention relates to overhead cranes and, in particular, to overhead cranes for use in applications spanning indoor and outdoor areas.

### BACKGROUND

Overhead cranes, also referred to as bridge cranes, are generally constructed with two parallel rails, called runways, attached to I-beam supports or other existing structure around a building such as a warehouse or manufacturing facility. A bridge spans between the runways and is mounted on the runways so as to move in one dimension along the runways. A hoist is mounted on a track or rail on the bridge and slides or is moved along the bridge, between the runways to provide for lifting and carrying heavy items within the area defined by the runways.

In many applications, such as in warehouses or manufacturing facilities, trucks are loaded or unloaded with cranes. If the unloading is done with an outdoor crane, the load has to be placed on a cart and then rolled through a door to the interior where another indoor crane has to unload the cart. On the other hand, if the building is constructed so that a truck can back into the building under an indoor crane for loading and unloading, this requires a large interior area to be devoted to loading and unloading trucks. Aside from the large area required, frequent truck traffic in an interior space is undesirable for a number of reasons, including making it difficult to keep the area clean.

There have been previous attempts to address these issues, including by using overhead cranes with runways that run continuously from an indoor area to an outdoor area. However, these overhead cranes either do not permit a door to close over the opening through which the runways pass, creating security and climate control issues, or they require custom-fitted doors that are specially made to close around the runways. These custom doors are complicated and expensive.

Accordingly, there is a need for an overhead crane that is able to operate across an indoor and outdoor area while permitting a standard door to close over the opening between the two areas.

### SUMMARY OF THE INVENTION

A gap jumping overhead crane, according to the present invention, is used with two parallel runways each having a first and second end and a gap between their first and second ends. The crane has a hoist mounted on a bridge having opposing ends that extends between the two parallel runways. The bridge is slidably mountable to the two parallel runways at each of its ends by an end truck. Each end truck has two ends and at least three load wheels attached to the end truck. At least two of the load wheels are separated by a distance greater than the size of the gap.

In another embodiment, each end truck has at least three guide wheels attached to the end truck and at least two of the guide wheels are separated by a distance greater than the size of the gap.

In another embodiment, the load wheels are oriented to support the weight of the crane on the runways and the guide wheels are oriented to prevent lateral movement as the crane travels along the runways.

In another embodiment, a bridge drive is attached to each end of one of the end trucks and engaged with one of the runways to drive movement of the crane along the runways.

In another embodiment, the crane is configured to be used with more than two parallel runways, with one or more intermediate runways between and parallel to the two parallel runways. The crane has one or more intermediate trucks, each with the same configuration as the end trucks, positioned between the end trucks to engage the one or more intermediate runways.

In another embodiment, the crane is configured to be used with a monorail runway, having a single runway. The crane has a trolley with the same configuration as one of the end trucks and the hoist is attached to the trolley.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is an isometric view of a gap jumping overhead crane, according to the present invention, shown mounted on two parallel runways.

FIG. 2 is an isometric view of the crane of FIG. 1, shown mounted on two parallel runways extending from an interior area through a door and over an outdoor truck loading area.

FIG. 3 is an isometric view of the crane of FIG. 1, shown without the runways.

FIG. 4 is an isometric view of one end truck of the crane of FIG. 1.

FIG. 5 is an isometric view of the other end truck of the crane of FIG. 1, showing bridge drives at both ends of the end truck.

FIG. 6 is an isometric view of the crane of FIG. 1, shown beginning to cross the gap in the runways.

FIG. 7 is another isometric view of the crane of FIG. 6, shown from below the runways.

FIG. 8 is an isometric view of the crane of FIG. 1, shown crossing the gap in the runways.

### DESCRIPTION OF THE INVENTION

The gap jumping overhead crane, according to the present invention, has specialized end trucks that enable the crane to cross a gap in the parallel runways on which the overhead crane travels. This allows the parallel runways to span between an indoor space and an outdoor space and permits a standard sliding or roll-up door to close through the gap in the runways. In applications such as around shipping doors, this allows the overhead crane to travel through the shipping door when the door is open and load items from the indoor shipping area directly onto a truck and vice versa. When not in use, the indoor shipping area can be closed off from the outside, for example, for security and climate control reasons. Other applications are also possible, such as room-to-room transfers that are entirely indoors, for example, for transfers between a production area and a climate-controlled storage area.

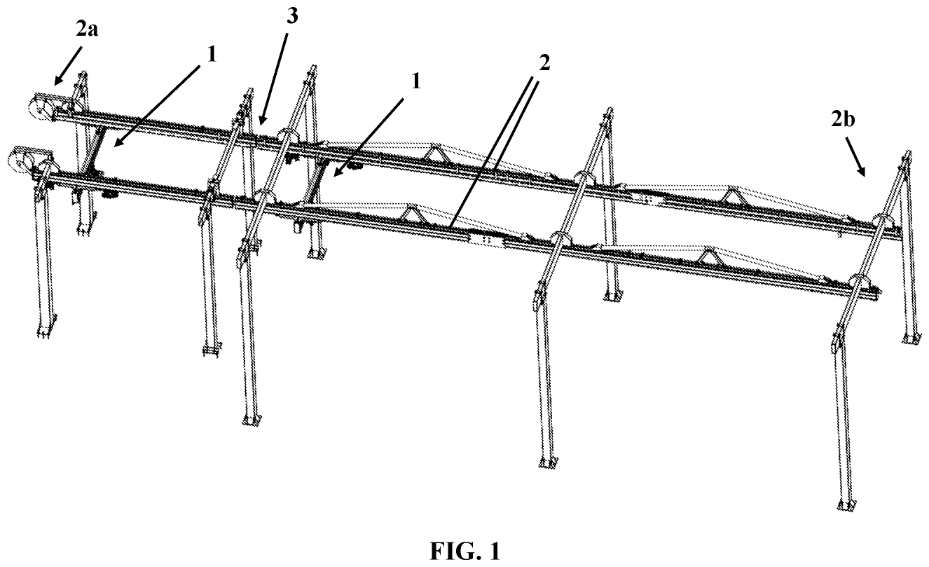

As shown in FIG. 1, the crane 1 is suspended on two parallel runways 2 having a gap 3 in each of the runways to permit a door to close and open through the gap, without coming into contact with the runways 2 on either side. The gap 3 in each of the runways 2 is located at generally the same point between the two opposing ends 2a and 2b of the runways 2. The runways 2 are aligned on either side of the gap 3, so as to minimize any disruption to the movement of the crane 1 along the runways 2 as it passes over the gap 3. The runways 2 may be of any configuration suitable for overhead cranes, such as enclosed track or I-beam style runways. The crane 1 may also be used in applications with any number of runways 2, including monorail applications with a single runway 2. Preferably, the crane 1 is used in an enclosed track, two-runway configuration, as described and illustrated herein.

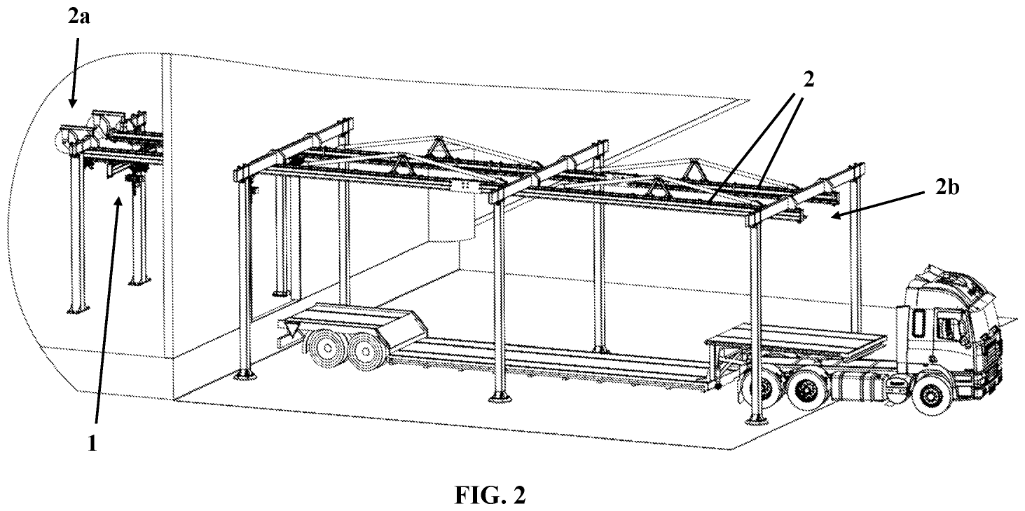

Preferably, one end 2a of the runways 2 is located in an indoor area and the other end 2b of the runways 2 located in an outdoor area, as shown in FIG. 2. Alternatively, the entire length of the runways 2 may be located indoors, on either side of an interior door that opens and closes through the gap 3. In either case, the gap 3 is sized and positioned in the doorway, such that a door may open and close through the gap 3 without coming into contact with the runways 2. Preferably, any standard sliding or roll-up door may be used, either that slides vertically or horizontally in and out of the doorway.

The invention is described herein with reference to an embodiment where the crane is supported only from below on the runways, but enclosed track configurations that support the load wheels 9 from above and below are also possible. In these embodiments, fewer or less spaced-apart wheels are required, at a minimum, to allow the crane to move smoothy across a gap in the runways 2 and the length L of the end trucks 6 may be smaller than twice the size of the gap 3. In these embodiments, there must be at least three load wheels 9 and at least two of the load wheels 9 must be separated by a distance greater than the size of the gap 3. In other embodiments, such as where the runways 2 only support the load wheels 9 from below, there must be at least two load wheels 9 separated by a distance greater than the size of the gap 3 on either side of the centre of gravity between the ends 6a of each end truck 6 (or trolley). The centre of gravity is preferably the midpoint between the ends 6a, but may be offset towards one end, for example, depending on where the bridge 5 is attached.

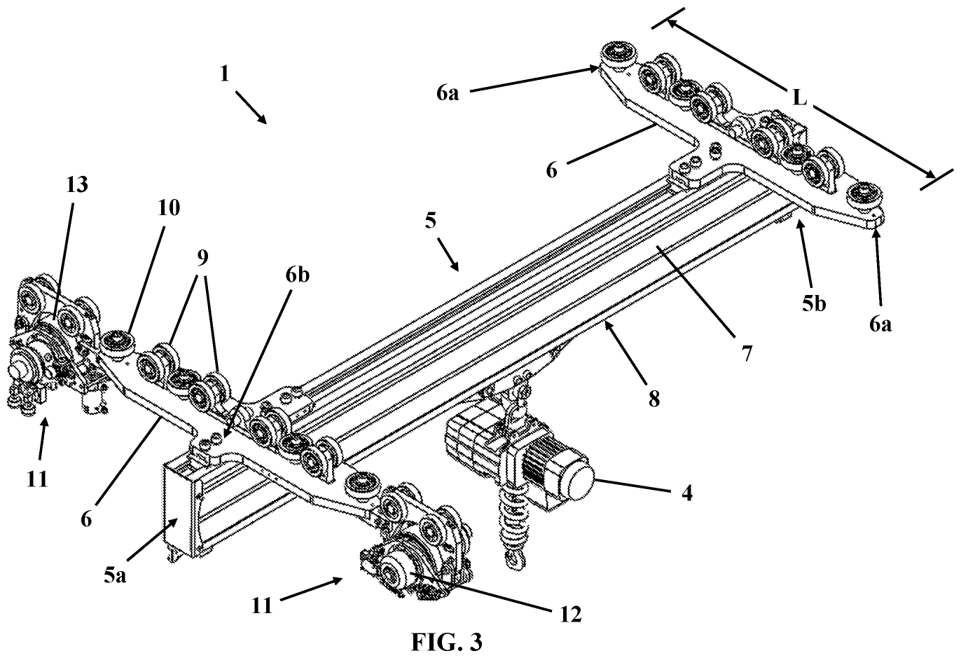

As shown in FIG. 3, the crane 1 has a hoist 4 suspended from a bridge 5 having an end truck 6 attached at each opposing end 5a and 5b of the bridge 5 for engaging with the runways 2. The hoist 4 may be any suitable type of hoist, such as an electric, pneumatic, or manual chain or wire rope hoist. The bridge 5 has a bridge girder 7 that extends between the opposing ends 5a and 5b of the bridge 5 and provides structural support for the hoist 4 and a track 8, or rail, on which the hoist 4 travels along at least a portion of the length of the bridge 5. Where required, such as when a pneumatic hoist is used, another track may be provided on the bridge 5 for the festooning to provide the compressed air line (or electrical power or electronics connection) to the hoist 4.

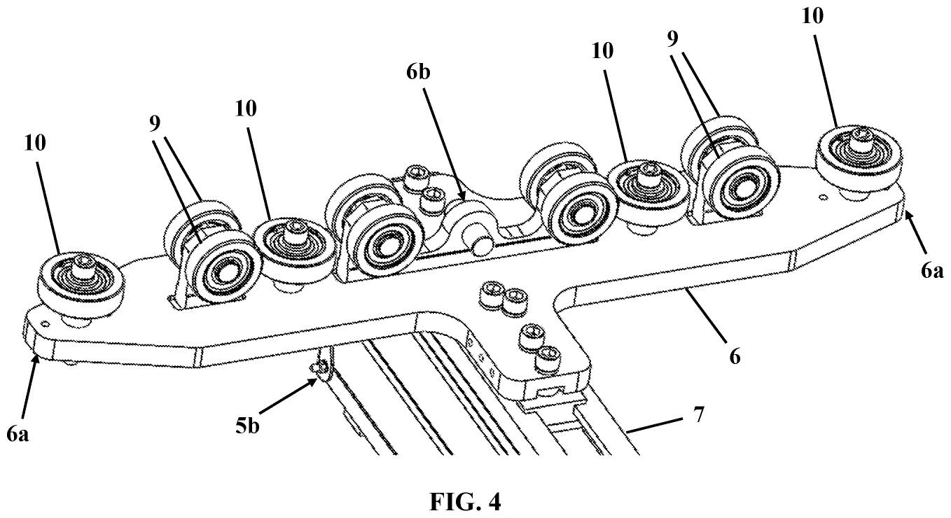

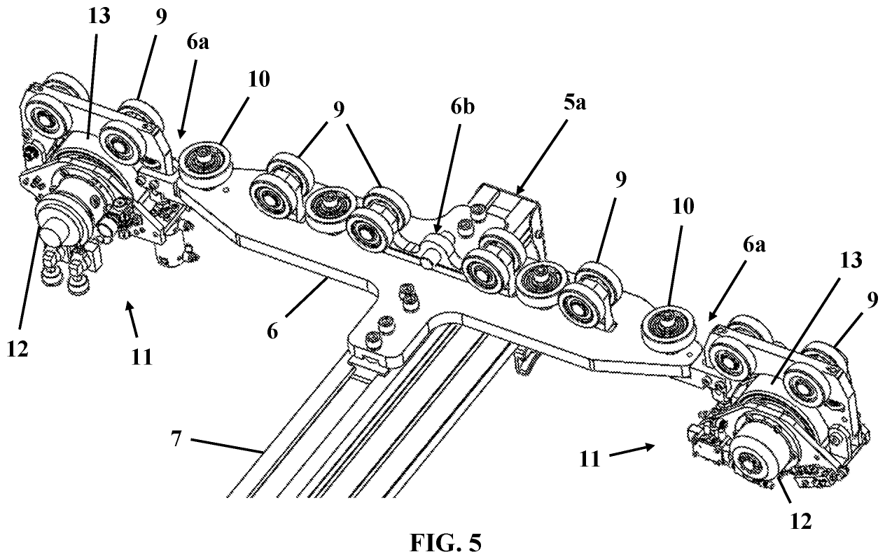

The end trucks 6 engage with the runways 2 by way of a plurality of load wheels 9 and guide wheels 10. As shown in FIGS. 4 and 5, the load wheels 9 are oriented vertically to support the weight of the crane 1 as it travels on the runways 2, while the guide wheels 10 are oriented horizontally to prevent lateral movement as the crane 1 travels and maintain the load wheels 9 on the runways 2. The end trucks 6 are rigidly attached to the ends 5a and 5b of the bridge 5 and extend outwardly from the bridge 5 along the runways 2. Each end truck 6 has opposing ends 6a separated by a length L that is at least twice the size of the gap 3 in the runways 2. Preferably, each end truck 6 is attached to the respective end 5a or 5b of the bridge 5 at a midpoint 6b between the ends 6a of the end truck 6.

Each end truck 6 has at least three load wheels 9 spaced apart between the opposing ends 6a of the end truck 6. Preferably, as shown in FIGS. 4 and 5, each end truck 6 has eight load wheels 9, with four load wheels 9 positioned in axially aligned pairs on either side of the midpoint 6b of the end truck 6. Regardless of the number of load wheels 9 attached to each end truck 6, the load wheels 9 are positioned such that at least two load wheels 9 are positioned between the midpoint 6b and each end 6a of the end truck 6 and are separated by a distance greater than the size of the gap 3. As a result, the crane 1 is always supported by at least one wheel between the midpoint 6b and each end 6a of the end trucks 6 as it travels over the gap 3. The transition of the crane 1 across the gap 3 in the runways 2 is explained in more detail, below.

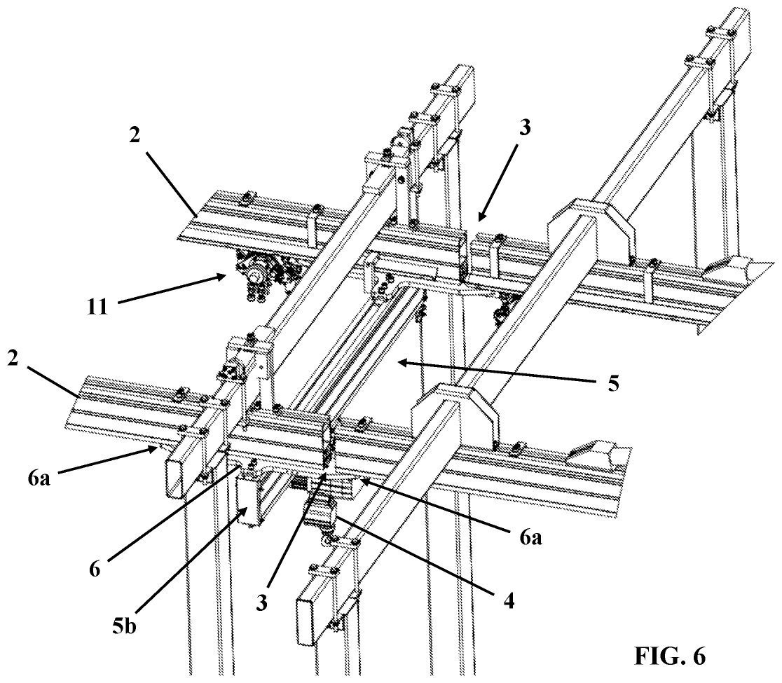

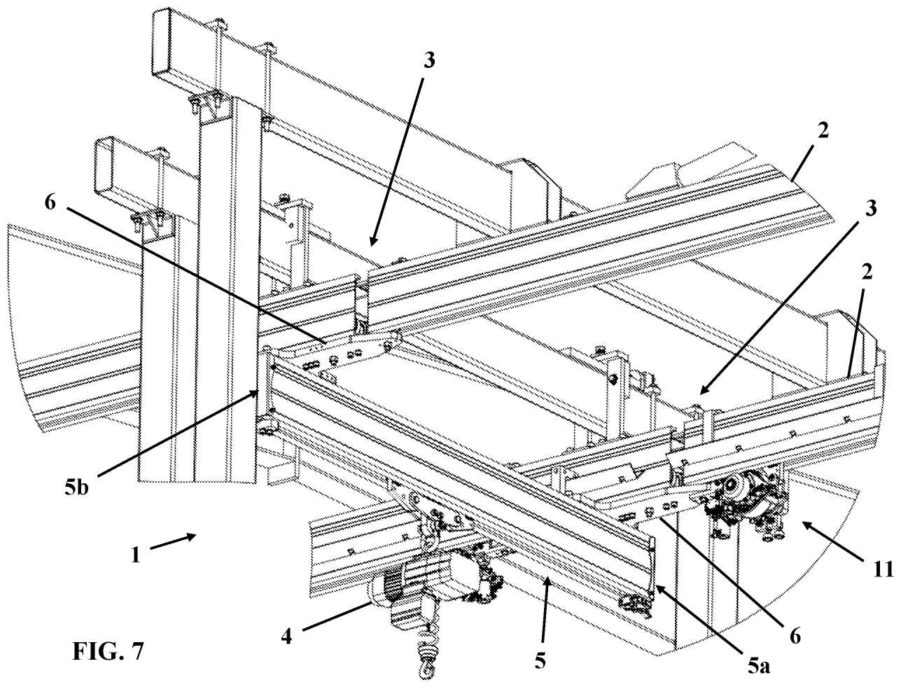

As shown in FIGS. 6 and 7, as the crane 1 begins crossing the gap 3 in the runways 2 the load wheel 9 closest to the leading end 6a of the end truck 6 moves over the gap 3 and is no longer in contact with the runways 2. This wheel is prevented from dropping into the gap 3 because the weight of the crane 1 is supported by the remaining load wheels 9, at least one of which is positioned between the midpoint 6b and the leading end 6a of the end trucks 6. As a result, the load wheel 9 at the leading end 6a maintains its alignment while passing over the gap 3 and smoothly transitions back onto the runways 2 on the other side.

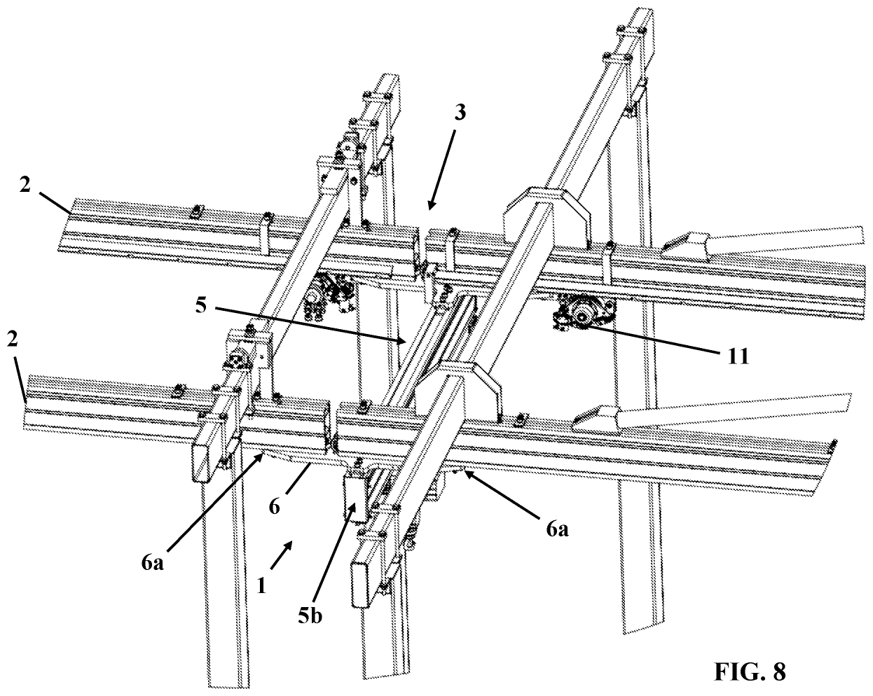

As the crane 1 continues to move along the runways 2, the load wheel 9 at the leading end 6a of the end truck 6 is in contact with the runways 2 on the other side of the gap 3 and again supports the weight of the crane 1. The crane 1 continues to move and other load wheels 9 similarly move over the gap 3 until the midpoint 6b of the end trucks moves over the gap 3. As shown in FIG. 8, at this point, the majority of the crane 1 is now supported by the runways 2 on the other side of the gap 3, but the end truck 6 still extends over the gap 3. As the first load wheel 9 on the trailing end 6a of the end track 6 moves over the gap 3, at least one other load wheel 9 between the midpoint 6b and the trailing end 6a remains in contact with the runways 2.

Preferably, each of the load wheels 9 are spaced apart by a distance greater than the size of the gap 3. However, there may be configurations of the crane 1 where there are more than two load wheels 9 between the midpoint 6b and each end 6a of the end trucks 6. In such configurations, it is possible to space the load wheels 9 more closely together, such that two or more load wheels 9 may be separated by a distance less than the size of the gap 3. This would result in two or more load wheels 9 being positioned over the gap 3 at the same time, as the crane 1 moves along the runways 2 over the gap 3. As long as at least two of the load wheels 9 on each side of the end trucks 6 are separated by a distance greater than the size of the gap 3, the alignment of the crane 1 will still be maintained as it crosses the gap 3.

As shown in FIGS. 4 and 5, the guide wheels 10 have a similar configuration to the load wheels 9 in terms of their spacing and positioning on the end trucks 6. Each end truck 6 has at least three guide wheels 10, preferably four guide wheels 10, with at least two positioned between the midpoint 6b and each end 6a of each end truck 6 and spaced apart by a distance greater than the size of the gap 3. In this way, the guide wheels 10 are able to support the crane 1 (laterally) as it moves along the runways 2 and across the gap 3 in essentially the same way described above for the load wheels 9.

The crane 1 may be used in a variety of applications, some of which will involve loads that are sufficiently light that the crane 1 may be manually operated (i.e. without power to move the hoist 4 along the bridge 5 or the crane 1 along the runways 2). However, many applications of overhead cranes involve loads that are far too heavy to be safely moved with a manually operated crane 1. In these applications, bridge drives 11, also referred to as tractors, are used to move the crane 1 along the runways 2. In some applications, tractors may also be used similarly to move the hoist 4 along the bridge 5.

As shown in FIG. 5, one of the end trucks 6 at one end 5a of the bridge 5 may be provided with two bridge drives 11 each with a motor 12 powering one or more drive wheels 13. The drive wheels 13 are oriented vertically and engage with the runways 2 in a similar way to the load wheels 9, but are powered by their respective motor 12 to drive the movement of the crane 1 along the runways 2. As shown in FIG. 5, the bridge drives 11 may also have one or more load wheels 9, such that the drive wheels 13 engage with the underside of the runway 2, while the load wheels 9 engage with the topside of the runway 2. This configuration is generally used with enclosed track-style runways 2, due to the limited space inside (and accessibility to) the interior of the runways 2. Other configurations may permit the drive wheels 13 to ride on top of the runways 2 with the load wheels 9, such as configurations where the crane 1 travels on top of I-beam style rail runways 2.

One of the bridge drives 11 is, preferably, attached to each end 6a of the end truck 6, so that the bridge drives 11 are spaced apart from each other. In this way, when drive wheel 13 of the bridge drive 11 at the leading end 6a of the end truck 6 passes over the gap 3, the drive wheel 13 of the other bridge drive 11 at the trailing end 6a of the end truck 6 remains engaged with the runways 2 and can provide drive to continue the movement of the crane 1 across the gap 3. Similarly, the bridge drive 11 at the leading end 6a of the end truck 6 can provide drive while the drive wheel 13 of the drive bridge 11 at the trailing end 6a passes over the gap 3. This prevents the crane 1 from losing momentum and getting stuck with the drive wheel 13 of a single bridge drive 11 positioned over the gap 3.

Alternatively, other configurations of the bridge drives 11 are also possible, as long as the drive wheels 13 of the two bridge drives 11 are spaced apart by a distance greater than the size of the gap 3. It is also possible to use a single bridge drive 11 with at least two drive wheels 13 separated by a distance greater than the size of the gap 3. Further, where the type of runway 2 permits, such as where the crane 1 travels on top of a rail, the end truck 6 at one end 5a of the bridge 5 may be modified, such that the drive wheels 13 of one or both bridge drives 11 replace one or more of the load wheels 9 of the end truck 6. In this way one of the end trucks 6 may be shortened, or rather the length L of the end truck includes one or both of the bridge drives 11, so long as at least two wheels (either load wheel 9 or drive wheel 13) between the midpoint 6b and each end 6a of the end truck 6, including one or both bridge drives 11, are separated by a distance greater than the size of the gap 3 in the runways 2.

The crane 1 has been described and illustrated in relation to an application with only two parallel runways 2, but it may be used in applications with three or more parallel runways 3. In these applications, one or more intermediate runways 2 are positioned between and parallel to the two parallel runways 2. The crane 1 has one or more intermediate trucks 6, which are configured the same as the end trucks 6, and positioned to engage with the one or more intermediate runways 2. This configuration may be useful where particularly heavy loads are required to move over a wide area, in order to provide adequate support along the length of the bridge 5 as the hoist 4 travels across the bridge 5 between the runways 2.

Alternatively, the crane 1 may be configured to be used with a monorail, having a single runway 2. In these applications, the crane 1 does not have a bridge 5 and the hoist 4 is attached to a trolley (not shown), having the same configuration as one of the end trucks 6. An additional set of guide wheels 10 may be provided on the trolley to provide additional stability as the trolley moves along the single runway 2, depending on the configuration of the monorail. The trolley travels along the runway 2 either manually or using trolley drives, which have the same configuration as the bridge drives 11.

The present invention has been described and illustrated with reference to an exemplary embodiment, however, it will be understood by those skilled in the art that various changes may be made and equivalents may be substituted for elements thereof without departing from the scope of the invention as set out in the following claims. Therefore, it is intended that the invention not be limited to the particular embodiments disclosed herein.

What is claimed is:

1. A gap jumping overhead crane, for use with two parallel runways each having a first and second end and a gap between their first and second ends, the crane comprising:
a hoist mounted on a bridge having opposing ends and extending between the two parallel runways;
wherein the bridge is slidably mountable to the two parallel runways at each of its ends by an end truck;
wherein each end truck has two ends and at least three load wheels attached to the end truck; and
wherein at least two of the load wheels are separated by a distance greater than the size of the gap.

2. The gap jumping overhead crane of claim 1, wherein each end truck has at least three guide wheels attached to the end truck, and wherein at least two of the guide wheels are separated by a distance greater than the size of the gap.

3. The gap jumping overhead crane of claim 2, wherein the load wheels are oriented to support the weight of the crane on the runways.

4. The gap jumping overhead crane of claim 3, wherein the guide wheels are oriented to prevent lateral movement as the crane travels along the runways.

5. The gap jumping overhead crane of claim 4, wherein each end truck has a centre of gravity between the ends and at least two of the load wheels between the centre of gravity and each end of the end truck are separated by a distance greater than the size of the gap.

6. The gap jumping overhead crane of claim 5, wherein at least two of the guide wheels between the centre of gravity and each end of the end truck are separated by a distance greater than the size of the gap.

7. The gap jumping overhead crane of claim 4, wherein each end truck has at least four load wheels.

8. The gap jumping overhead crane of claim 7, wherein each end truck has eight load wheels positioned in axially aligned pairs.

9. The gap jumping overhead crane of claim 4, wherein the bridge has a track extending along at least a portion of the bridge and the hoist is slidably mounted on the track.

10. The gap jumping overhead crane of claim 4, comprising two or more bridge drives attached to one of the end trucks and spaced apart by a distance greater than the size of the gap, wherein each of the two or more bridge drives has a motor powering a drive wheel engaged with the runway to drive the movement of the crane along the runway.

11. The gap jumping overhead crane of claim 10, wherein one bridge drive is attached to each end of one of the end trucks.

12. The gap jumping overhead crane of claim 10, wherein the drive wheel of one or more of the bridge drives is one or more of the load wheels.

13. The gap jumping overhead crane of claim 4, comprising a bridge drive attached to one of the end trucks and having a motor powering at least two drive wheels engaged with the runway to drive the movement of the crane along the runway and separated by a distance greater than the size of the gap.

14. The gap jumping overhead crane of claim 13, wherein one or more of the at least two drive wheels is one or more of the load wheels.

15. The gap jumping overhead crane of claim 4, wherein the two parallel runways comprise one or more intermediate runways parallel to the two parallel runways and having a first and second end and a gap between the first and second end;
wherein the bridge is slidably mountable to the one or more intermediate runways by one or more intermediate trucks;
wherein each intermediate truck has two ends and at least three load wheels and at least three guide wheels attached to the intermediate truck; and
wherein at least two of the load wheels and at least two of the guide wheels are separated by a distance greater than the size of the gap.

16. A gap jumping overhead crane, for use with a monorail runway having a first and second end and a gap between the first and second end, the crane comprising:
a hoist mounted on a trolley having two ends and at least three load wheels attached to the trolley; and
wherein at least two of the load wheels are separated by a distance greater than the size of the gap.

17. The gap jumping overhead crane of claim 16, wherein the trolley has at least three guide wheels attached to the trolley, and wherein at least two of the guide wheels are separated by a distance greater than the size of the gap.

18. The gap jumping overhead crane of claim 17, wherein the load wheels are oriented to support the weight of the crane on the runways and the guide wheels are oriented to prevent lateral movement as the crane travels along the runways.

19. The gap jumping overhead crane of claim 18, comprising two or more trolley drives attached to the trolley and spaced apart by a distance greater than the size of the gap, wherein each of the two or more trolley drives has a motor powering a drive wheel engaged with the runway to drive the movement of the crane along the runway.

20. The gap jumping overhead crane of claim 18, comprising a trolley drive attached to the trolley and having a motor powering at least two drive wheels engaged with the runway to drive the movement of the crane along the runway and separated by a distance greater than the size of the gap.
